(19) United States
(12) Patent Application Publication
(10) Pub. No.: US 2026/0371244 A1
(43) Pub. Date: Nov. 19, 2026

(54) TERMINAL DEVICE AND BASE STATION DEVICE

(71) Applicant: 1FINITY Inc., Kawasaki-shi (JP)

(72) Inventor: Ryosuke KOBAYASHI, Kawasaki (JP)

(73) Assignee: 1FINITY Inc., Kawasaki-shi (JP)

(21) Appl. No.: 19/739,079

(22) Filed: Jul. 13, 2026

Related U.S. Application Data
(63) Continuation of application No. PCT/JP2024/005409, filed on Feb. 16, 2024.

(51) Int. Cl. H04W 52/02

(52) U.S. Cl. CPC H04W 52/0229

(57) ABSTRACT

A terminal device includes: a first receiver configured to receive a first signal including first information; a second receiver configured to receive a second signal; and a controller configured to perform control to receive a paging signal via the first receiver in response to the second receiver receiving the second signal, wherein the controller is further configured to determine whether or not to perform control to receive the paging signal via the first receiver according to whether or not a first condition indicated by the first information is satisfied.

### CROSS-REFERENCE TO RELATED APPLICATION

This application is a continuation application of International Application Number PCT/JP2024/005409 filed on Feb. 16, 2024 and designated the U.S., the entire contents of which are incorporated herein by reference.

### FIELD

The present disclosure relates to a terminal device and a base station device used in a radio communication system.

### BACKGROUND

In current networks, traffic of mobile terminals (smartphones, feature phones, and the like) occupies most of resources of the network. Further, traffic used by mobile terminals tends to expand in the future.

In addition, Internet of Things (IoT) services (for example, a traffic system, a smart meter, and a monitoring system of a device or the like) have been deployed in various fields. For this reason, the network is expected to cope with services having various demands. Then, in order to cope with such various services, for example, in a fifth generation mobile communication (5G or New Radio (NR)) communication standard (for example, Non-Patent Literatures 1 to 14), a standard has been formulated assuming support of many use cases classified into enhanced Mobile BroadBand (eMBB), massive Machine Type Communications (MTC), and Ultra-Reliable and Low Latency Communication (URLLC). In addition, the communication standard of the fifth generation mobile communication also defines a technique for suppressing power consumption of the terminal device.

As one of techniques (UE power saving) for suppressing power consumption of a terminal device, Paging Early Indicator (PEI) has been introduced. PEI is a technology in which a network device (for example, a base station) notifies a terminal device of presence or absence of paging before the terminal device receives a paging signal (Non-Patent Literatures 6 and 7).

Further, in the 3rd Generation Partnership Project (3GPP (registered trademark)), as a new technology for suppressing power consumption of a terminal device, a low power wake-up signal and receiver has been studied (Non-Patent Literature 15). In the case of implementing low power wake up signal and receiver, the terminal device includes a receiver (low power receiver) having low power consumption and a receiver (main radio unit) for performing data communication. Here, when the terminal device is not performing data communication (for example, in an idle state), the terminal device controls the low power receiver to operate and the main radio unit not to operate. Then, when receiving the wake-up signal via the low power receiver, the terminal device activates the main radio unit.

### CITATION LIST

### Non-Patent Literature

Non-Patent Literature 1: 3GPP TS 37.324 V17.0.0
Non-Patent Literature 2: 3GPP TS 37.340 V17.7.0
Non-Patent Literature 3: 3GPP TS 38.201 V17.0.0
Non-Patent Literature 4: 3GPP TS 38.202 V17.5.0
Non-Patent Literature 5: 3GPP TS 38.211 V17.6.0
Non-Patent Literature 6: 3GPP TS 38.212 V17.7.0
Non-Patent Literature 7: 3GPP TS 38.213 V17.8.0
Non-Patent Literature 8: 3GPP TS 38.214 V17.8.0
Non-Patent Literature 9: 3GPP TS 38.215 V17.4.0
Non-Patent Literature 10: 3GPP TS 38.300 V17.7.0
Non-Patent Literature 11: 3GPP TS 38.321 V17.7.0
Non-Patent Literature 12: 3GPP TS 38.322 V17.3.0
Non-Patent Literature 13: 3GPP TS 38.323 V17.5.0
Non-Patent Literature 14: 3GPP TS 38.331 V17.7.0
Non-Patent Literature 15: 3GPP TR 38.869 V18.0.0

In the foregoing terminal device, one receiver may be able to detect or receive a signal, while the other receiver may be unable to detect or receive a signal. Thus, for example, although the main radio unit is able to receive a signal, when the low power receiver is unable to detect a signal, the main radio unit is not activated, and the terminal device is unable to receive a data signal. Note that, in the communication method using the PEI described above, since the PEI and a signal designated by the PEI are received by the same receiver (for example, a main radio unit), the above-described situation does not occur.

### SUMMARY

A terminal device includes, a first receiver that receives a first signal including first information, a second receiver that receives a second signal, and a controller that performs control to receive a paging signal via the first receiver in response to the second receiver receiving the second signal, wherein the controller determines whether or not to perform control to receive the paging signal via the first receiver according to whether or not a first condition indicated by the first information is satisfied.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 illustrates an example of a radio communication system according to an embodiment.

FIGS. 2A to 2B illustrate an example of a method in which the terminal device 2 detects paging from the base station 1.

FIG. 3 illustrates an example of a configuration of a terminal device.

FIG. 4 illustrates an example of the wake-up receiver 22.

FIG. 5 is a diagram illustrating an example of a case where a paging signal is not receivable.

FIG. 6 illustrates an example of a sequence for implementing a fallback operation of the terminal device 2.

FIG. 7 is a flowchart illustrating an example of a fallback start procedure.

FIG. 8 is a flowchart illustrating another example of the fallback start procedure.

FIG. 9 is a flowchart illustrating an example of the fallback end procedure.

FIG. 10 is a flowchart illustrating another example of the fallback end procedure.

### DESCRIPTION OF EMBODIMENTS

Hereinafter, an embodiment will be described in detail with reference to the drawings. Problems and examples in the present specification are merely exemplary and do not limit the claims of the present application. In particular, the technology of the present application can be applied to even different expressions as long as the expressions are technically equivalent even if the expressions are different, and the scope of rights is not limited. Then, each embodiment can be appropriately combined within a range in which there is no contradiction in processing contents.

In addition, for the terms and technical contents described in the present specification, terms and technical contents described in specifications and contributions as standards related to communications, such as 3GPP, may be appropriately used. Such a specification is, for example, Non-Patent Literatures 1 to 15.

Hereinafter, examples of a base station device, a terminal device, a radio communication system, and a communication method disclosed in this application will be described in detail with reference to the drawings. Note that the following examples do not limit the disclosed technique.

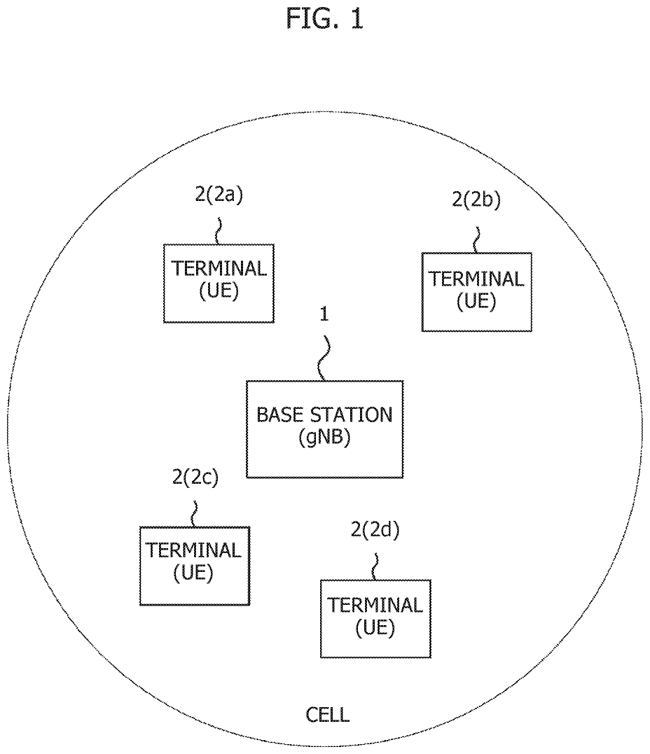

FIG. 1 illustrates an example of a radio communication system according to an embodiment. The radio communication system according to the embodiment includes a base station 1 and a terminal device 2 (2a to 2d). The base station 1 is not particularly limited, but is, in this example, a next generation Node B (gNB) or a New Radio (NR) base station. The terminal device 2 is, for example, User Equipment (UE).

The base station 1 forms a cell. Then, the base station 1 accommodates the terminal device 2 located in the cell. That is, the base station 1 transmits a radio signal to each terminal device 2 and receives a radio signal from each terminal device 2. Each terminal device 2 transmits a radio signal to the base station 1 and receives a radio signal from the base station 1.

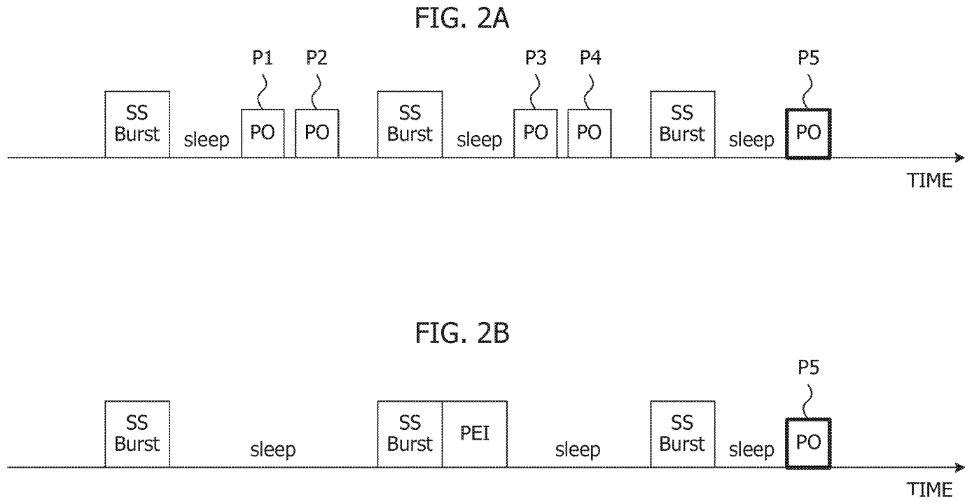

FIG. 2 illustrates an example of a method in which the terminal device 2 detects paging from the base station 1. In this example, the terminal device 2a detects paging from the base station 1.

The paging is transmitted at a timing designated by the base station 1. In the case illustrated in FIG. 2A, Paging Occasions (PO) P1 to P5 are set. The timing of each paging occasion is represented by a Synchronization Signal Block (SSB). Then, the base station 1 notifies each terminal device 2 of the paging occasion. In addition, each terminal device 2 acquires the SSB in an SS burst and recognizes the paging occasion. Thus, the terminal device 2a is able to acquire paging addressed to the terminal device 2a by detecting a reception signal at each paging occasion.

However, in the case illustrated in FIG. 2A, the time taken to establish synchronization with the base station 1 becomes long. In addition, the terminal device 2a needs to monitor all paging occasions. For example, even in a case where a paging signal is transmitted to the terminal device 2a using the paging occasion P5, the terminal device 2a needs to monitor not only the paging occasion P5 but also the paging occasions P1 to P4. Thus, the sleep time is shortened, and the power consumption is insufficiently reduced.

In order to cope with this problem, in Release 17 of 3GPP, Paging Early Indicator (PEI) illustrated in FIG. 2B is proposed as one of power saving methods. The PEI notifies the destination terminal of the transmission of the paging signal in advance. For example, when paging to be received by the terminal device 2a is set, the base station 1 uses PEI to notify the terminal device 2a of a message indicating a paging occasion at which the terminal device 2a is to receive the paging signal. In this case, the terminal device 2a monitors the PEI. Then, the terminal device 2a receives the paging signal in the paging occasion (in FIG. 2B, P5) designated by the PEI. According to this method, since not all paging occasions need to be monitored, a sleep time becomes long and power consumption of the terminal device 2 is reduced as compared with the method illustrated in FIG. 2A. However, in a use case where the frequency of receiving paging is low, power consumption for monitoring PEI becomes dominant.

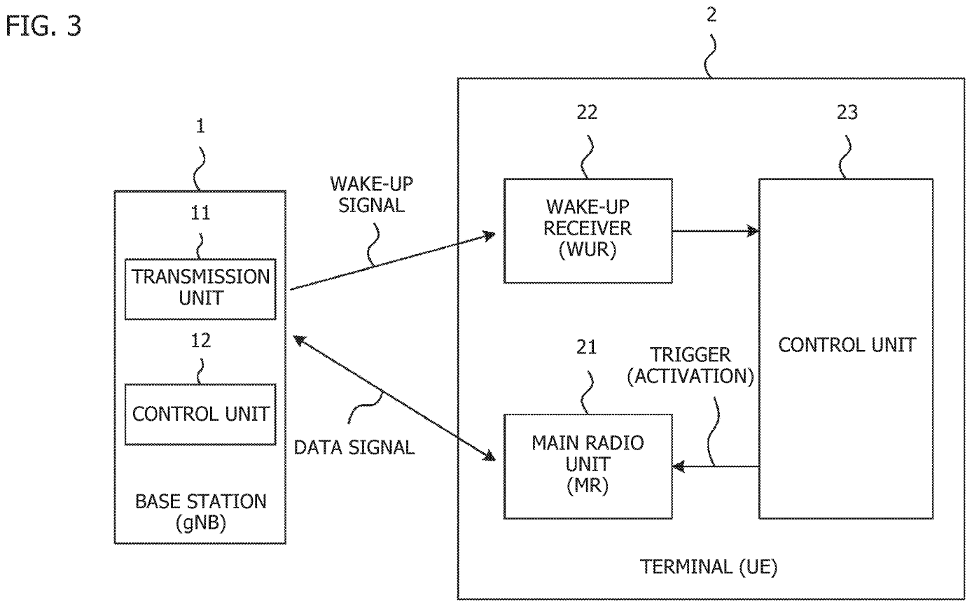

FIG. 3 illustrates an example of a configuration of a terminal device. The terminal device 2 includes a main radio unit 21, a wake-up receiver 22, and a control unit 23. Note that the terminal device 2 may further include other circuits, devices, or functions not illustrated in FIG. 3.

The Main Radio unit (MR) 21 receives a radio signal from the base station 1 and transmits the radio signal to the base station 1. However, when the terminal device 2 does not perform data communication, the main radio unit 21 is controlled to be in a sleep mode. Note that “data communication” is not limited to communication of user data and includes communication of a control signal related to data communication. The main radio unit 21 may be a functional block for receiving a data signal. In addition, the main radio unit 21 may include a digital signal processor for processing a reception signal.

The Wake-Up Receiver (WUR) 22 receives a Low Power Wake-Up Signal (LP-WUS) transmitted from the base station 1. Here, when communicating with the terminal device 2, the base station 1 transmits a wake-up signal to the terminal device 2. Then, when the wake-up receiver 22 detects the wake-up signal, the main radio unit 21 is activated. Thereafter, the terminal device 2 receives a radio signal transmitted from the base station 1 using the main radio unit 21. As an example, a paging signal transmitted from the base station 1 is received using the main radio unit 21. In this case, the main radio unit 21 receives the paging signal by the method illustrated in FIG. 2A or 2B.

The wake-up receiver 22 receives a synchronization signal (Low Power Synchronization Signal (LP-SS)) in order to establish synchronization of the wake-up signal with the base station 1. The synchronization signal LP-SS is a broadcast signal transmitted from the base station 1 at a predetermined cycle, and is also used to measure Radio Resource Management (RRM) of the serving cell.

The wake-up signal (and the synchronization signal LP-SS) is not particularly limited, but is transmitted by, for example, On-Off Keying (OOK). In this case, the wake-up receiver 22 is able to detect the wake-up signal by detection in the time domain. Therefore, the configuration of the wake-up receiver 22 is simple, and power consumption is very small as compared with the main radio unit 21. Note that the main radio unit 21 and the wake-up receiver 22 may share an antenna.

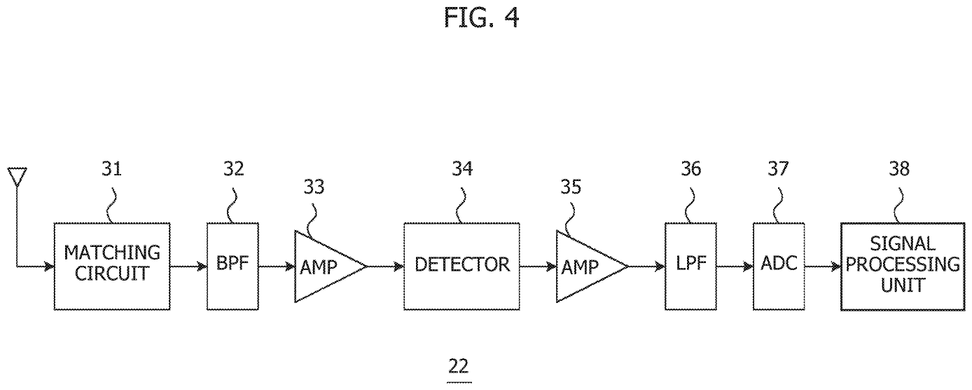

FIG. 4 illustrates an example of the wake-up receiver 22. In this example, it is assumed that the wake-up receiver 22 receives an OOK signal. The wake-up receiver 22 includes a matching circuit 31, a Band-Pass Filter (BPF) 32, an amplifier 33, a detector 34, an amplifier 35, a Low-Pass Filter (LPF) 36, an Analog-To-Digital Converter (ADC) 37, and a signal processing unit 38.

The matching circuit 31 adjusts impedance between the antenna and a reception circuit. The band pass filter 32 extracts a frequency component in which a signal (wake-up signal, synchronization signal LP-SS, or the like) is arranged in a radio frequency (RF) region. The amplifier 33 is an RF low noise amplifier and amplifies an output signal of the band pass filter 32. The detector 34 is, for example, an envelope detector, and detects an envelope (that is, an amplitude modulation signal) from a reception signal.

The amplifier 35 is a baseband amplifier and amplifies an output signal of the detector 34. The low-pass filter 36 removes high frequency components. The analog-to-digital converter 37 converts an output signal of the low-pass filter 36 into digital data. That is, digital data representing the reception signal is generated. Then, the signal processing unit 38 processes digital data representing the reception signal. That is, the signal processing unit 38 processes the reception signal.

The control unit 23 controls the main radio unit 21 and the wake-up receiver 22. That is, the control unit 23 can activate the main radio unit 21 in response to the wake-up receiver 22 receiving the wake-up signal. “Activating the main radio unit 21” includes enabling the main radio unit 21 to receive a signal transmitted from the base station 1. Further, the control unit 23 can control the operation or function of the wake-up receiver 22 on the basis of information notified from the base station 1. Note that the control unit 23 includes, for example, a processor and a memory. In this case, the function of the terminal device 2 is provided by the processor executing a program stored in the memory.

The base station 1 includes a transmission unit 11 and a control unit 12. The transmission unit 11 can transmit a control signal, a wake-up signal, a paging signal, and the like to be described later to the terminal device 2 in accordance with an instruction from the control unit 12. The control unit 12 controls the transmission unit 11.

Thus, the terminal device 2 activates the main radio unit 21 in response to reception of the wake-up signal by the wake-up receiver 22. That is, the main radio unit 21 is triggered or activated in response to reception of the wake-up signal. Then, the activated main radio unit 21 is able to receive the paging signal transmitted from the base station 1.

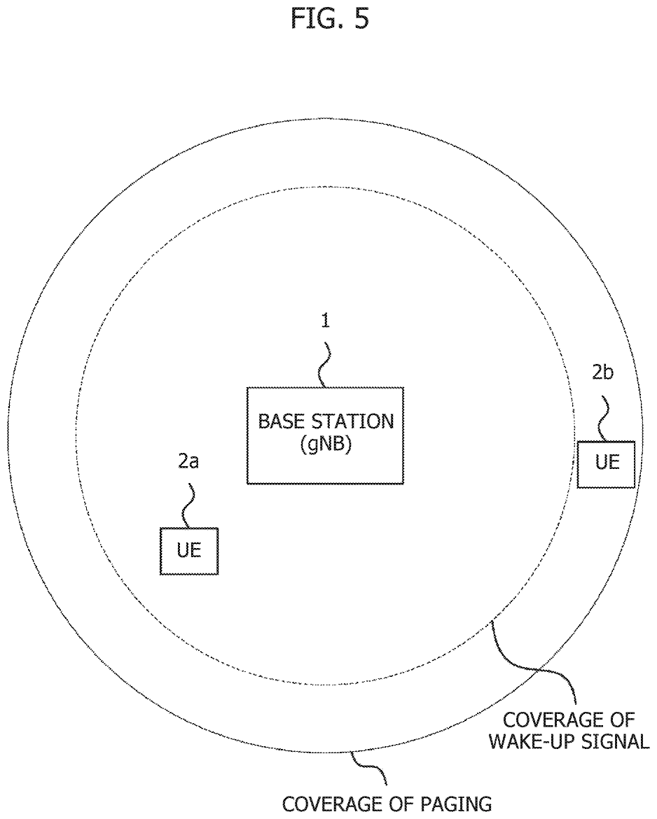

However, the paging signal is received by the main radio unit 21, and the wake-up signal is received by the wake-up receiver 22. For this reason, there may be a case where the wake-up signal is not receivable although the paging signal is receivable. For example, in the case illustrated in FIG. 5, coverage of the wake-up signal is narrower than coverage of paging. In this case, the terminal device 2a is able to receive both the wake-up signal and the paging signal. That is, when receiving the wake-up signal, the terminal device 2a is able to subsequently receive the paging signal. On the other hand, the terminal device 2b is able to receive the paging signal but is unable to receive the wake-up signal. That is, although the terminal device 2b is able to receive the paging signal, the main radio unit 21 is not activated, and thus an occasion to receive the paging signal is lost.

Accordingly, even when the wake-up signal is not detected, the terminal device 2 according to the embodiment activates the main radio unit 21 when a predetermined condition is satisfied (alternatively, when the predetermined condition is not satisfied). In this manner, when the base station 1 transmits a paging signal, the terminal device 2 is able to receive the paging signal via the main radio unit 21.

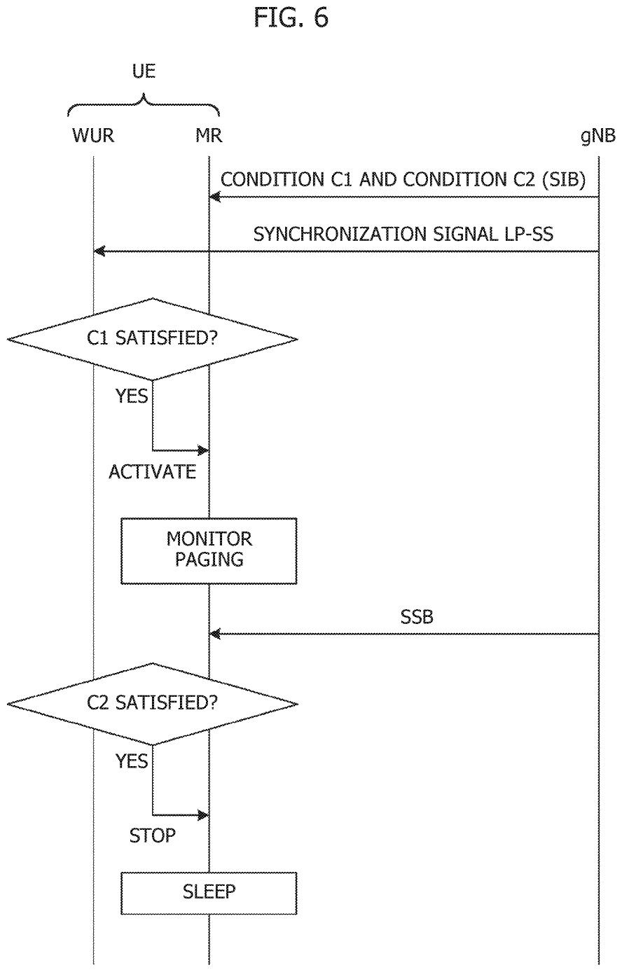

FIG. 6 illustrates an example of a sequence for implementing a fallback operation of the terminal device 2. Note that, as illustrated in FIG. 3, the terminal device 2 includes the main radio unit 21, the wake-up receiver 22, and the control unit 23. Here, when data communication is not performed between the base station 1 and the terminal device 2, the main radio unit 21 is controlled to be in the sleep mode. Then, when the wake-up receiver 22 receives the wake-up signal from the base station 1, the control unit 23 activates the main radio unit 21.

The base station 1 notifies the terminal device 2 of a condition C1 and a condition C2 relating to the fallback operation of the terminal device 2. The condition C1 is used to determine whether or not the terminal device 2 starts the fallback operation. The condition C2 is used to determine whether or not the terminal device 2 ends the fallback operation. Note that the condition C1 and the condition C2 are notified from the base station 1 to the terminal device 2 using, for example, a System Information Block (SIB) in this example.

When the main radio unit 21 is controlled to be in the sleep mode in the terminal device 2, the wake-up receiver 22 monitors the wake-up signal transmitted from the base station 1. At this time, the wake-up receiver 22 monitors the wake-up signal on the basis of the synchronization signal LP-SS transmitted from the base station 1.

The terminal device 2 monitors whether or not the condition C1 is satisfied. Then, when the condition C1 is satisfied, the terminal device 2 starts the fallback operation. That is, when the condition C1 is satisfied, the control unit 23 activates the main radio unit 21 even when the wake-up receiver 22 does not receive the wake-up signal from the base station 1. Then, the main radio unit 21 monitors paging from the base station 1. Note that examples of the condition C1 will be described later.

After the main radio unit 21 is activated, the terminal device 2 monitors whether or not the condition C2 is satisfied. Then, when the condition C2 is satisfied, the terminal device 2 ends the fallback operation. Specifically, the state of the main radio unit 21 returns to the sleep mode. Note that examples of the condition C2 will be described later.

As described above, by the sequence according to the embodiment, when the condition C1 is satisfied while the main radio unit 21 is controlled to be in the sleep mode, the main radio unit 21 is activated even when the wake-up receiver 22 does not receive the wake-up signal from the base station 1. Thus, if the condition C1 is appropriately set, the terminal device 2 is able to monitor paging even when the wake-up signal is not receivable. Therefore, a situation in which “although the main radio unit 21 is able to receive a signal, due to the wake-up receiver 22 being unable to detect a signal, the terminal device 2 is unable to receive a paging signal” is avoided or suppressed.

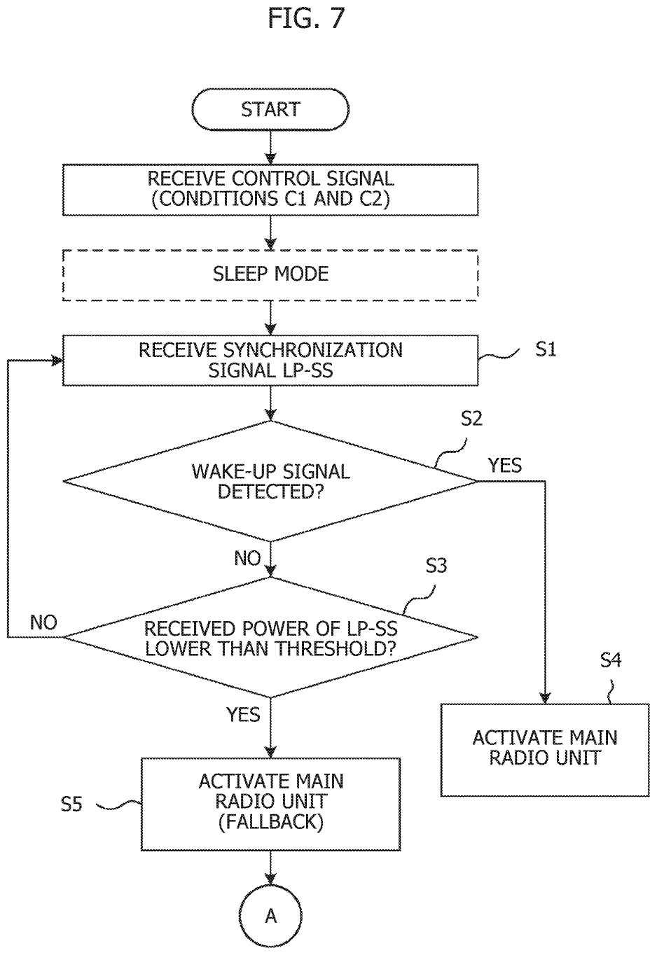

FIG. 7 is a flowchart illustrating an example of a fallback start procedure. Note that, it is assumed that the terminal device 2 receives a control signal indicating the condition C1 and the condition C2 from the base station 1. The control signal is transmitted from the base station 1 to the terminal device 2 by using the SIB in this example. Thus, the terminal device 2 receives the control signal using the main radio unit 21.

In the case illustrated in FIG. 7, the condition C1 is expressed by using a threshold relating to the reception level of the signal. Specifically, the condition C1 is that “received power of the synchronization signal LP-SS is lower than a predetermined threshold level.” Although the threshold level is not particularly limited, for example, when transmission power of the synchronization signal LP-SS and transmission power of the wake-up signal are the same or substantially the same, the threshold level may be the same as the threshold for determining whether or not the terminal device 2 receives the wake-up signal. Note that the synchronization signal LP-SS is a synchronization signal for the wake-up receiver 22 of each terminal device 2 to receive a signal, and is broadcast by the base station 1 at predetermined time intervals.

In addition, in the example illustrated in FIG. 7, it is assumed that the main radio unit 21 is controlled to be in the sleep mode after the terminal device 2 receives the above-described control signal. Then, the terminal device 2 waits for a signal (synchronization signal LP-SS and wake-up signal) transmitted from the base station 1 using the wake-up receiver 22.

In S1, the wake-up receiver 22 receives the synchronization signal LP-SS. Then, the control unit 23 detects the power of the synchronization signal LP-SS received by the wake-up receiver 22. That is, the received power of the synchronization signal LP-SS is detected.

In S2, the control unit 23 monitors the wake-up signal using the wake-up receiver 22. Note that the timing at which the wake-up signal is transmitted from the base station 1 can be recognized on the basis of the synchronization signal LP-SS. Then, when the wake-up signal is detected, the control unit 23 activates the main radio unit 21 in S4. Thereafter, the main radio unit 21 monitors paging. That is, the terminal device 2 performs the operation illustrated in FIG. 2A or FIG. 2B.

Here, the cause of the terminal device 2 not receiving the wake-up signal is considered to be one of the following two cases.
(1) The base station 1 is not transmitting the wake-up signal.
(2) The base station 1 is transmitting the wake-up signal, but the terminal device 2 is unable to receive the wake-up signal.

Then, when the cause of the terminal device 2 not receiving the wake-up signal is the case (2), the situation in which “although the main radio unit 21 is able to receive a signal, due to the wake-up receiver 22 being unable to detect a signal, the terminal device 2 is unable to receive a paging signal” may occur. Accordingly, in order to identify the cause of not receiving the wake-up signal, the control unit 23 compares the received power of the synchronization signal LP-SS with the threshold level used by the condition C1 in S3. As a result, if the received power of the synchronization signal LP-SS is lower than the threshold level, it is estimated that the case (2) may have occurred. In this case, the control unit 23 determines that the condition C1 is satisfied. Then, in S5, the control unit 23 activates the main radio unit 21. Thereafter, the main radio unit 21 monitors paging. Note that, in S5, the control unit 23 activates the main radio unit 21 in the fallback mode. When the main radio unit 21 is activated in the fallback mode, a fallback end procedure to be described later is executed.

Note that the case where the wake-up signal is not detected and the received power of the synchronization signal LP-SS is higher than the threshold level occurs when the terminal device 2 is able to receive the wake-up signal but the base station 1 does not transmit the wake-up signal. Thus, in this case, the processing of the terminal device 2 returns to S1 in order to continue waiting for the wake-up signal.

As described above, in the example illustrated in FIG. 7, when the received power of the synchronization signal LP-SS is lower than the threshold level, the main radio unit 21 is activated regardless of whether or not the wake-up receiver 22 receives the wake-up signal. Here, when the received power of the synchronization signal LP-SS is lower than the threshold level, it is considered that the terminal device 2 is unable to receive the wake-up signal. That is, when the received power of the synchronization signal LP-SS is lower than the threshold level, there is a possibility that the wake-up receiver 22 is unable to receive the wake-up signal even though the wake-up signal is transmitted from the base station 1. Then, in a case where the wake-up signal is transmitted from the base station 1, there is a possibility that the paging signal is then transmitted from the base station 1. Thus, the control unit 23 monitors paging by activating the main radio unit 21. Therefore, when the paging signal is transmitted from the base station 1, the terminal device 2 is able to receive the paging signal using the main radio unit 21.

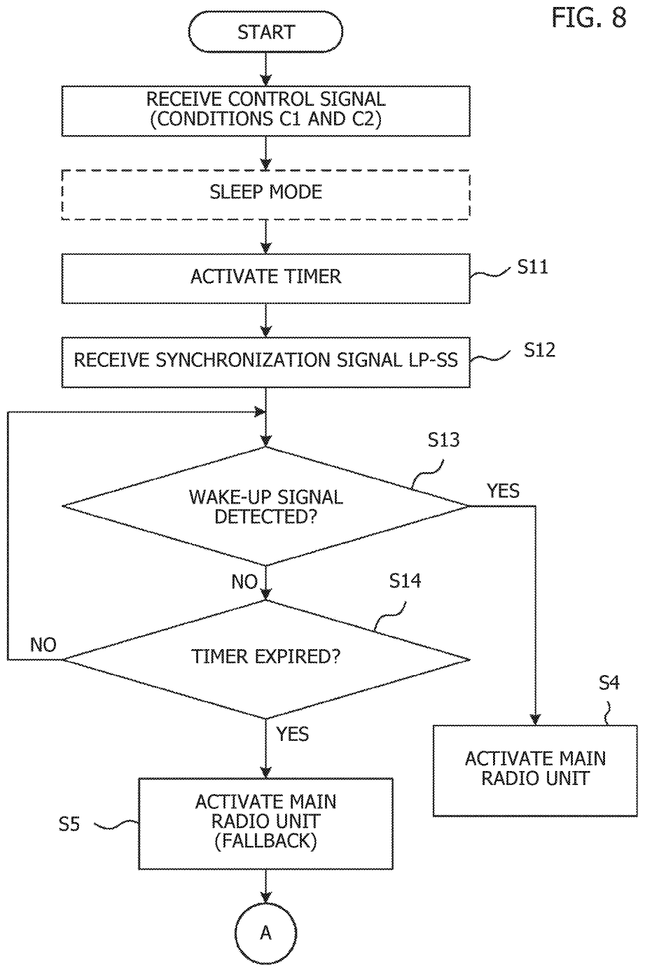

FIG. 8 is a flowchart illustrating another example of the fallback start procedure. In the case illustrated in FIG. 8, the condition C1 is expressed by using a timer period for waiting for the wake-up signal. Specifically, the condition C1 is “no wake-up signal is received within a predetermined timer period.” The timer period is not particularly limited, but may be, for example, several seconds to several minutes. In addition, this timer period is notified from the base station 1 to the terminal device 2 using the SIB.

When a predetermined time elapses after the terminal device 2 receives the SIB, the main radio unit 21 shifts to the sleep mode. Then, when the main radio unit 21 shifts to the sleep mode, the control unit 23 activates the timer in S11. The timer is implemented in the control unit 23, for example. Thereafter, the terminal device 2 waits for the synchronization signal LP-SS and the wake-up signal using the wake-up receiver 22.

In S12, the terminal device 2 receives the synchronization signal LP-SS. Then, the control unit 23 sets a reception timing for receiving the wake-up signal.

In S13 to S14, the control unit 23 monitors whether or not the wake-up receiver 22 receives the wake-up signal. Then, when the wake-up receiver 22 receives the wake-up signal before the timer expires, the control unit 23 activates the main radio unit 21 in S4. Thereafter, the main radio unit 21 monitors paging.

On the other hand, when the timer expires without the wake-up receiver 22 receiving wake-up signaling, the control unit 23 determines that the condition C1 is satisfied. In this case, the control unit 23 activates the main radio unit 21 in S5. Thereafter, the main radio unit 21 monitors paging. Note that, in S5, the control unit 23 activates the main radio unit 21 in the fallback mode.

As described above, in the example illustrated in FIG. 8, when the terminal device 2 does not receive the wake-up signal continuously for a predetermined time, the main radio unit 21 is activated. Therefore, if the wake-up receiver 22 is unable to receive the wake-up signal but the main radio unit 21 is able to receive the paging signal, the terminal device 2 is able to receive the paging signal. For example, in the case illustrated in FIG. 5, the terminal device 2b is unable to receive the wake-up signal. In this case, when the main radio unit 21 is activated according to the procedure illustrated in FIG. 8, the terminal device 2 is able to receive the paging signal.

Note that, in the example illustrated in FIG. 8, the timer is reset when the wake-up receiver 22 receives the wake-up signal, but the processing of the control unit 23 is not limited to this procedure. That is, the timer need not be reset when the wake-up receiver 22 receives the wake-up signal. In this case, the control unit 23 activates the main radio unit 21 periodically regardless of whether or not the wake-up receiver 22 receives the wake-up signal.

In the above-described example, the control unit 23 activates the main radio unit 21 when the condition C1 is satisfied. However, depending on the description of the condition C1, the control unit 23 may activate the main radio unit 21 when the condition C1 is not satisfied. In the example illustrated in FIG. 7, if the condition C1 is that the “received power of the synchronization signal LP-SS is lower than a predetermined threshold level,” the main radio unit 21 is activated when the condition C1 is satisfied, but if the condition C1 is “received power of the synchronization signal LP-SS is higher than a predetermined threshold level,” the main radio unit 21 is activated when the condition C1 is not satisfied. Further, in the example illustrated in FIG. 8, if the condition C1 is “the wake-up signal is not received within the predetermined timer period,” the main radio unit 21 is activated when the condition C1 is satisfied, but if the condition C1 is “the wake-up signal is received within the predetermined timer period,” the main radio unit 21 is activated when the condition C1 is not satisfied.

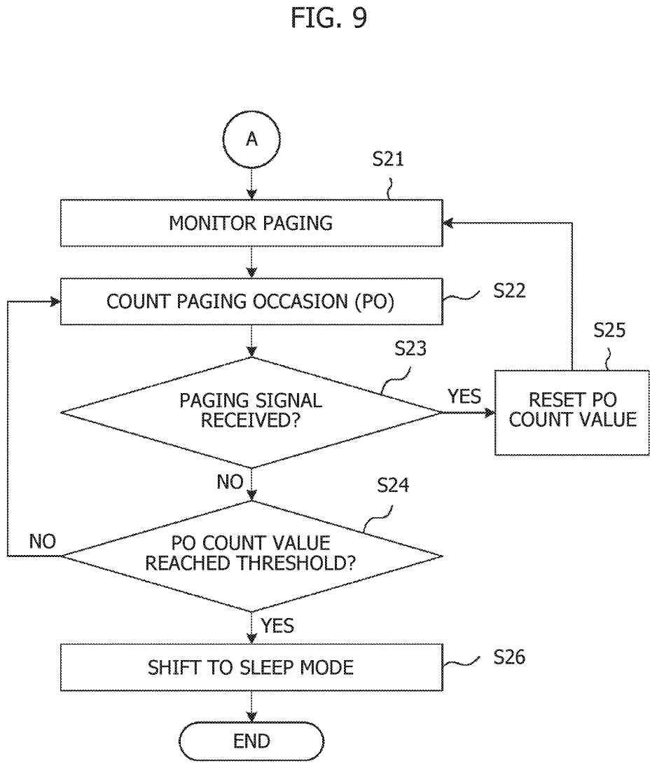

FIG. 9 is a flowchart illustrating an example of the fallback end procedure. The fallback end procedure is executed, for example, when the main radio unit 21 is started in the fallback mode in S5 illustrated in FIG. 7 or FIG. 8. Further, as described with reference to FIG. 7, the terminal device 2 recognizes the condition C2 by receiving the SIB from the base station 1.

The condition C2 is “no paging signal is received continuously for a predetermined period” in this example. The predetermined period may be “time” clocked by the timer or may be the number of Paging Occasions (PO). In the example illustrated in FIG. 9, the predetermined period is represented by the number of paging occasions. In this case, the condition C2 is “no paging signal is received in a predetermined number of paging occasions.” Note that the paging occasion is assumed to be set at predetermined time intervals on the basis of, for example, the SSB.

In S21, the terminal device 2 monitors paging using the main radio unit 21. In S22, when the paging occasion is reached, the control unit 23 counts the number of paging occasions. That is, a PO count value indicating the number of paging occasions is incremented.

In S23, the control unit 23 determines whether or not the main radio unit 21 has received the paging signal. When the main radio unit 21 receives the paging signal, the terminal device 2 processes the paging signal. In addition, the control unit 23 resets the PO count value in S25. Thereafter, the processing of the terminal device 2 returns to S21. As described above, when the main radio unit 21 receives the paging signal, the terminal device 2 continues the operation of monitoring paging.

When the main radio unit 21 does not receive the paging signal, the control unit 23 determines whether or not the PO count value has reached the threshold in S24. This threshold is used in the condition C2. Then, when the PO count value has not reached the threshold, the processing of the control unit 23 returns to S22. That is, when the main radio unit 21 does not receive the paging signal, the processing of S22 to S24 is repeatedly executed until the PO count value reaches the threshold. Then, when the PO count value reaches the threshold, the control unit 23 determines that the predetermined period represented by the condition C2 has elapsed. In this case, the control unit 23 shifts the main radio unit 21 to the sleep mode in S26.

As described above, when the paging signal is not received continuously for a predetermined period, the main radio unit 21 shifts to the sleep mode. Thereafter, the terminal device 2 waits for the wake-up signal using the wake-up receiver 22.

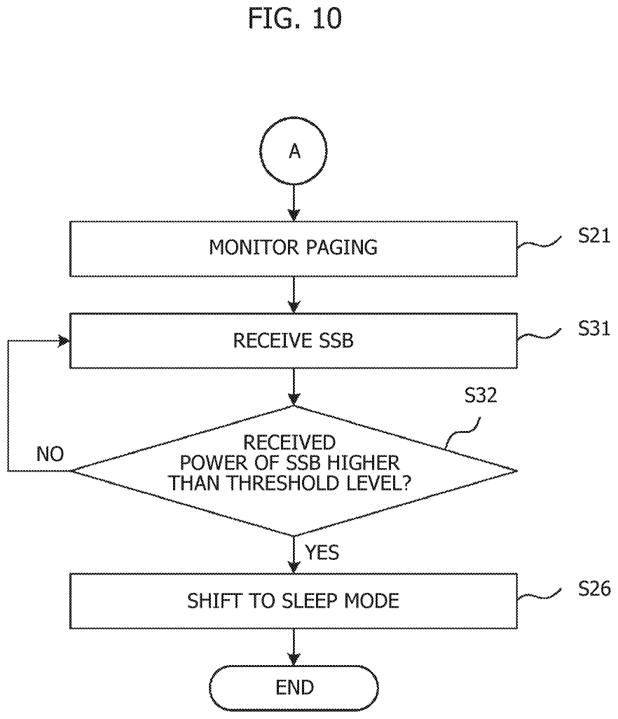

Note that the condition C2 may be described using other parameters. For example, in the example illustrated in FIG. 10, the condition C2 is expressed using the received power of the main radio unit 21. For example, the condition C2 is “received power of the SSB is higher than a predetermined threshold level.” Here, the SSB is synchronization information for the main radio unit 21 of each terminal device 2 to receive a signal, and is broadcast to each terminal device in the cell of the base station 1 at a predetermined transmission power.

In S31, the terminal device 2 receives the SSB using the main radio unit 21. Then, the control unit 23 detects the received power of the SSB. In S32, the control unit 23 compares the received power of the SSB with the threshold level used in the condition C2. Then, when the received power of the SSB is higher than the threshold level, the control unit 23 determines that the terminal device 2 is able to receive a signal from the base station 1. In this case, the control unit 23 shifts the main radio unit 21 to the sleep mode in S26.

As described above, when the radio wave condition of the terminal device 2 is good, the main radio unit 21 shifts to the sleep mode. Thereafter, the terminal device 2 waits for the wake-up signal using the wake-up receiver 22.

According to the above aspect, even when a terminal device is unable to receive a signal for activating a receiver, the terminal device is able to receive a signal related to data communication.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

### REFERENCE SIGNS LIST

1 BASE STATION
2 TERMINAL DEVICE
21 MAIN RADIO UNIT
22 WAKE-UP RECEIVER
23 CONTROL UNIT

What is claimed is:

1. A terminal device comprising:
a first receiver configured to receive a first signal including first information;
a second receiver configured to receive a second signal; and
a controller configured to perform control to receive a paging signal via the first receiver in response to the second receiver receiving the second signal, wherein
the controller is further configured to determine whether or not to perform control to receive the paging signal via the first receiver according to whether or not a first condition indicated by the first information is satisfied.

2. The terminal device according to claim 1, wherein
even when the second receiver does not receive the second signal, the controller performs control to receive the paging signal via the first receiver when the first condition is satisfied.

3. The terminal device according to claim 1, wherein
the first information represents a threshold relating to a reception level of a signal, and
when a reception level of a synchronization signal for receiving the second signal is lower than the threshold, the controller performs control to receive the paging signal via the first receiver.

4. The terminal device according to claim 1, wherein
the first information indicates a predetermined period, and
when the second receiver does not receive the second signal continuously for the predetermined period, the controller performs control to receive the paging signal via the first receiver.

5. The terminal device according to claim 1, wherein
the first information indicates a predetermined period, and
every time the predetermined period elapses, the controller performs control to receive the paging signal via the first receiver.

6. The terminal device according to claim 1, wherein
the first signal includes second information representing a second condition, and
when the second condition is satisfied after reception by the second receiver is stopped according to whether or not the first condition is satisfied, the controller controls the first receiver to be in a state of not receiving a signal.

7. The terminal device according to claim 6, wherein
the second information represents a second predetermined period, and
when the second predetermined period elapses from when the first receiver is activated, the controller controls the first receiver to be in a state of not receiving a signal.

8. The terminal device according to claim 7, wherein
the predetermined period is represented by a number of occasions for the first receiver to receive a third signal.

9. The terminal device according to claim 6, wherein
the second information represents a second threshold relating to a reception level of a signal, and
when the reception level of synchronization information received by the first receiver is higher than the second threshold, the controller controls the first receiver to be in a state of not receiving a signal.

10. A base station device connected to a terminal device, the base station device comprising:
a transmitter configured to transmit a first signal including first information and a second signal to the terminal device; and
a controller configured to perform control to transmit the second signal to the terminal device so as to cause the terminal device to transition to a state of receiving a paging signal, wherein
the first signal is received by a first receiver in the terminal device,
the second signal is received by a second receiver in the terminal device, and
the first condition indicated by the first information is used in the terminal device to determine whether or not the terminal device transitions to a state of receiving a paging signal.

11. A radio communication system comprising:
a base station device; and
a terminal device, wherein
the terminal device includes:
a first receiver;
a second receiver; and
a controller,
the base station device transmits a first signal including first information to the terminal device,
the first receiver receives the first signal,
the base station device transmits a second signal to the terminal device,
the controller performs control to receive a paging signal via the first receiver in response to the second receiver receiving the second signal, and
when the second receiver does not receive the second signal, the controller determines whether or not to perform control to receive a paging signal via the first receiver according to whether or not a first condition indicated by the first information is satisfied.
